(19) United States
(12) Patent Application Publication
(10) Pub. No.: US 2005/0114271 A1
(43) Pub. Date: May 26, 2005

(54) System and method to provide secure electronic records

(76) Inventor: Eugene Sindambiwe, Eppelheim (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/723,723

(22) Filed: Nov. 26, 2003

(51) Int. Cl. H04L 9/00

(52) U.S. Cl. 705/67

(57) ABSTRACT

A system and method to generate secure electronic records is disclosed. A client system may receive data associated with a transaction. The client may transfer the transaction data to a server system. The server system may generate a secure electronic record based, at least in part, on the data associated with the transaction. The generated secure electronic record may be transmitted to a plurality of clients.

### TECHNICAL FIELD

Embodiments of the invention generally relate to the field of electronic business forms and, more particularly, to a system and method to provide secure electronic records.

### BACKGROUND

Business transactions are typically documented in one or more business records. For example, the sale of a product or service may be memorialized in a receipt provided by the seller (or the seller's agent) to the buyer (or the buyer's agent). The receipt is typically printed on paper and signed by one or several individuals. The printed and signed receipt may then be physically transported to the buyer.

A buyer may want an electronic copy of the data provided in the receipt. For example, a buyer may maintain a database of business transaction records for various accounting purposes. The buyer may obtain an electronic version of the printed receipt by, for example, scanning it. A machine, however, cannot process the data contained in the scanned receipt. In order to obtain an electronic copy of the data provided in the receipt, a human typically reads, analyzes, and enters the data into an electronic application (e.g., a software program). The process of reading, analyzing, and entering data into a program by a human is time consuming (and therefore expensive) and error prone.

Private individuals and companies typically collect paper receipts and forward them to, for example, the responsible revenue office to seek partial tax reimbursement. These paper receipts are quite often sent to a tax advisor who then forwards them to the responsible revenue office. The usual practice at most revenue offices is for an employee to sift through the paper receipts, perform some analysis, and enter data extracted from the receipts into a software program used by the revenue office. As mentioned above, the process of reading, analyzing, and entering data into a program by a human is time consuming (and therefore expensive), tedious, and error prone.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of selected elements of distributed system 100 providing secure electronic record services according to an embodiment of the invention.

FIG. 2 is a block diagram of selected elements of distributed system 200 providing secure electronic record services according to an alternative embodiment of the invention.

FIG. 3 is a block diagram of selected elements of distributed system 300 providing secure electronic record services according to yet another alternative embodiment of the invention.

FIG. 4 is a block diagram illustrating the architecture of an embodiment of secure electronic agent 400.

FIG. 5 is a flow diagram illustrating certain aspects of a method for processing transaction data, according to an embodiment of the invention.

FIG. 6 is a flow diagram illustrating certain aspects of a method for generating a secure electronic record, according to an embodiment of the invention.

FIG. 7 is a block diagram of node 700 implemented according to an embodiment of the invention.

### DETAILED DESCRIPTION

Embodiments of the invention are generally directed to a system and method to provide secure electronic records. In an embodiment, a client system (e.g., a seller's software application) receives data associated with a transaction. The client may transfer the data associated with the transaction to a dedicated server system for providing secure electronic records. In an embodiment, the server system generates a secure electronic record responsive to receiving the transaction data from the client system. The server system may transmit at least a portion of the secure electronic record to one or more clients (e.g., a revenue office).

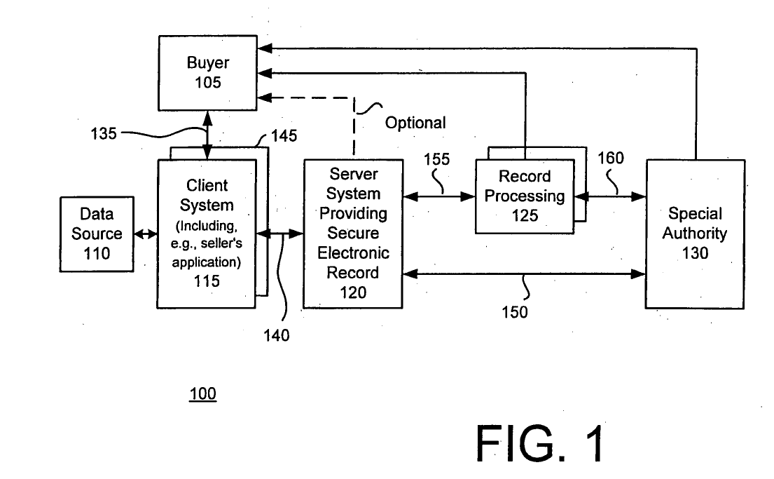

FIG. 1 is a block diagram of selected elements of distributed system 100 providing secure electronic record services according to an embodiment of the invention. Distributed system 100 includes buyer 105, data source 110, client system(s) 115, server system 120, record processing system(s) 125, and special authority system 130. As is further described below, in alternative embodiments of the invention, distributed system 100 may have more elements, fewer elements, and/or different elements than those illustrated in FIG. 1.

Buyer 105 represents a human and/or legal entity (e.g., a company) engaged in a business transaction with client system 115. In an embodiment, buyer 105 is a buyer who is purchasing a product or service from client system 115 and desires a secure electronic record to document the transaction. In an embodiment, buyer 105 is in the same geographical location as client system 115. In an alternative embodiment of the invention, buyer 105 is remotely located from client system 115 and interacts with client system 115 through a voice and/or data network. In an embodiment in which buyer 105 is remotely located from client system 115, connection 135 may be a wired or wireless connection including a Local Area Network (LAN), a Wide Area Network (WAN), a Metropolitan Area Network (MAN), and/or the Internet. The interaction between buyer 105 and client system 115 may be direct (e.g., without the assistance of an agent representing the seller) or may include one or more agents acting on behalf of buyer 105 and/or the seller who employs client system 115. In some embodiments of the invention, the interaction between buyer 105 and client system 115 is synchronous while, in alternative embodiments of the invention, the interaction is asynchronous.

In an embodiment, data source 110 contains data belonging to buyer 105 that is accessible to client system 115. Data source 110 may be a bankcard, flash memory device, optically encoded memory device, an electronic signal, or other machine-readable source of data. In an embodiment, data source 110 contains buyer specific data such as the buyer's address, the buyer's account number, etc.

In an embodiment, client system 115 is a computer system (e.g., including a seller's application and/or a cash register) used by a manufacturer, reseller, retailer, service provider, or the like. In contrast to conventional systems, client system 115 may receive transaction related data in a predetermined machine-readable format so that a human need not process and enter the transaction data. Also, in contrast to conventional systems, client system 115 does not directly issue a paper receipt. Instead, client system 110 requests the services of server system 120 to provide a secure electronic record corresponding to a transaction between client system 115 and buyer 105. In an embodiment, client system 115 exchanges information with server system 120 through connection 140. Connection 140 may be a wired or wireless connection including a Local Area Network (LAN), a Wide Area Network (WAN), a Metropolitan Area Network (MAN), and/or the Internet.

Server system 120 provides secure electronic records to one or more client system(s) 115. The term “server system” as it applies to server system 120 is merely a convenient way to express that server system 120 provides a service to, for example, client system 115. In an embodiment, the architecture connecting server system 120 and client system 115 may be, for example, a client-server architecture, a peer-to-peer architecture, a Web services architecture, and the like. For example, server system 120 may receive data from client system 115 related to a transaction between client system 115 and buyer 105 along with a request from client system 115 to generate a secure electronic record corresponding to the transaction. In an embodiment, the transaction is a sale of goods and/or services and the secure electronic record is a receipt documenting the sale. In an embodiment, server system 120 may be referred to as “secure electronic record server system” because it generates a secure electronic record of a third-party transaction. In an embodiment, client system 115 and server system 120 are integrated into the same computing system.

The term “third-party transaction” refers to a transaction between entities other than the system or module of the system that generates the secure electronic record. For example, in the illustrated embodiment, buyer 105 and client system 115 engage in a transaction, for example, the sale of a good(s) and/or a service(s). From server system 120's point of view, such a transaction is a third-party transaction because server system 120 is not one of the entities that is buying or selling the good(s) and/or the service(s). Thus, if server system 120 generates a secure electronic record of the transaction, it is generating a secure electronic record of a third-party transaction.

Reference numeral 145 indicates that a plurality of client systems 115 may request the services of server system 120. Since server system 120 may provide secure electronic record services to several clients, the implementer of server system 120 may make much larger investments in server system 120, particularly with regards to security, than any individual client could make. In an embodiment, server system 120 may provide a number of security mechanisms including: authentication, digital signatures, encryption, authorization, unique record numbers, access control for fields and areas of the generated electronic records, and/or “faceless receipts.” These security mechanisms, including “faceless receipts,” are further discussed below.

In an embodiment, server system 120 provides authenticated electronic records. The term authentication refers to verifying the identity of a user who is providing transaction data and/or verifying at least a portion of the transaction data. An example of an authentication scheme suitable for use with embodiments of the invention is the challenge-response authentication mechanism described in Request For Comments (RFC) 2617 entitled, “HyperText Transport Protocol (HTTP) Authentication: Basic and Digest Access Authentication,” June 1999. In an alternative embodiment, additional and/or other authentication mechanisms may be used.

In an embodiment, server system 120 provides electronic records having a digital signature. The term digital signature refers to an electronic mechanism for determining whether an electronic file has been altered. An example of a digital signature scheme suitable for use with embodiments of the invention is the digital signature scheme specified in RFC 3275 entitled, “EXtensible Markup Language (XML) Signature Syntax and Processing,” March 2002. In an alternative embodiment, additional and/or other digital signature schemes may be used.

Server system 120 may encrypt a portion (or the entirety) of a generated secure electronic record. In an embodiment, at least a portion of the generated electronic record is encrypted. An example of an encryption scheme suitable for use embodiments of the invention is the World Wide Web Consortium (W3C) Recommendation entitled, “XML Encryption Syntax and Processing,” 10 Dec. 2002 (hereinafter the XML Encryption Standard). In an alternative embodiment, additional and/or other encryption schemes may be used.

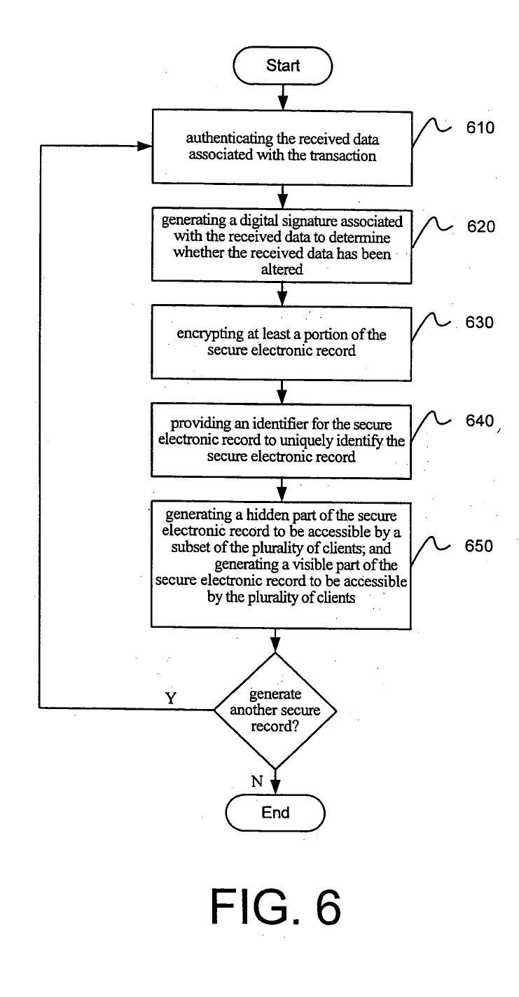

The term access control refers to specifying which receiver of a secure electronic record has access to which fields (and/or portions) of the secure electronic record. For example, server system 120 may encrypt selected portions of a secure electronic record and only selected receivers of the secure electronic record may be able to decrypt the encrypted portions. The term access control may also refer to designating selected portions of a secure electronic record as read-only portions. In an embodiment, the term access control may also refer to specifying a hidden portion (or portions) and a visible portion (or portions) of a secure electronic record. Secure electronic records having a hidden portion and a visible portion are further discussed below with reference to FIG. 6.

The term “faceless receipt” refers to a receipt that does not reveal the buyer's identity. In an embodiment, a faceless receipt may include a receipt that has a generic unique identifier. A generic unique identifier is a unique identifier for a secure electronic receipt that does not indicate who the buyer is. In an embodiment, a faceless receipt may or may not specify who the seller is.

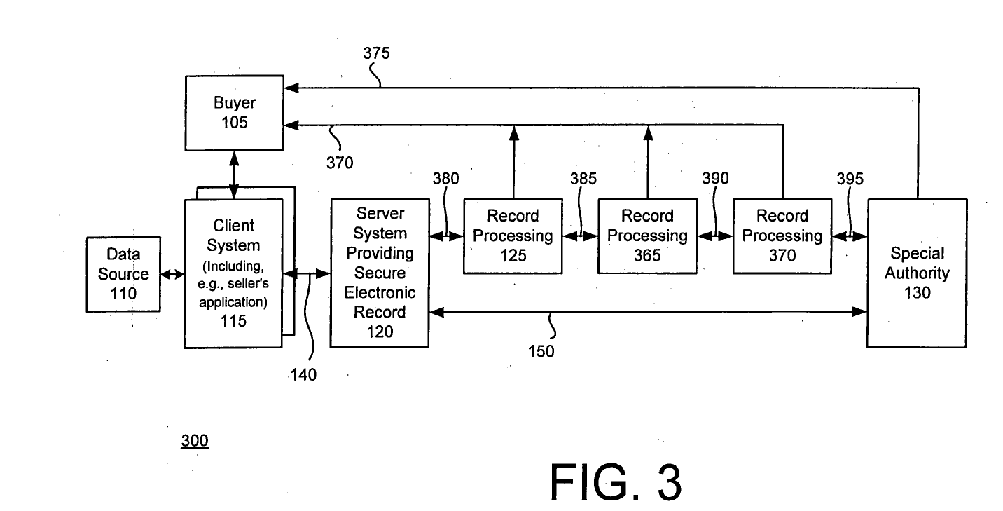

In an embodiment, client system 115 (and/or buyer 105) specifies one or more receivers for a generated secure electronic record. For example, buyer 105 may request that its tax adviser receives a copy of the generated secure electronic record. Record processing system 125 represents a specified receiver of a generated secure electronic record. Record processing system 125 is more fully described below with respect to FIG. 3.

In an embodiment, special authority 130 represents a receiver of a secure electronic record who potentially receives the record directly from server system 120 and one or more record processing systems 125. In an embodiment, special authority 130 is a tax authority (e.g., an agent of a federal tax authority) that receives and processes the secure electronic record in a uniform data format. In an embodiment, server system 120 may encode data according to any version of “The Unicode Standard,” for example Version 4.0, Reading, Mass., Addison-Wesley, 2003. ISBN 0-321-18578-1 (hereinafter, the Unicode Standard).

In an embodiment, the encoded data is structured according to the XML schema standard promulgated by the World Wide Web Consortium (W3C) entitled, “XML Schema Part 1: Structures and XML Schema Part 2: Datatypes,” 2 May 2001 (hereinafter, the XML Schema Standard). XML schemas provide a means for defining the structure, content, and semantics of XML documents. Since server system 120 and special authority 130 may exchange information using a uniform data format and shared data semantics, a minimum amount of human involvement is needed to exchange and process information. Since human involvement is greatly reduced, the frequency of errors and the cost of processing records are also greatly reduced.

In an embodiment, connections 150, 155, and 160 may connect server system 120, record processing system(s) 125, and special authority 130 as shown in FIG. 1. Connections 150, 155, and 160 may be wired or wireless connections including LANs, WANs, MANs, and/or the Internet. In an embodiment, the protocol described in RFC 2616 entitled, “HyperText Transport Protocol—HTTP/1.1,” June 1999 (hereinafter, the HTTP Protocol) is the transport protocol used by buyer 105, data source 110, client system 115, server system 120, record processing system 125, and/or special authority 130. In an embodiment, at least some of the elements of distributed system 100 implement RFC 2246 entitled, “The Transport Layer Security Protocol Version 1.0,” January 1999 (hereinafter, the HTTPS Protocol) as the transport protocol. In an alternative embodiment other transport protocols may be used.

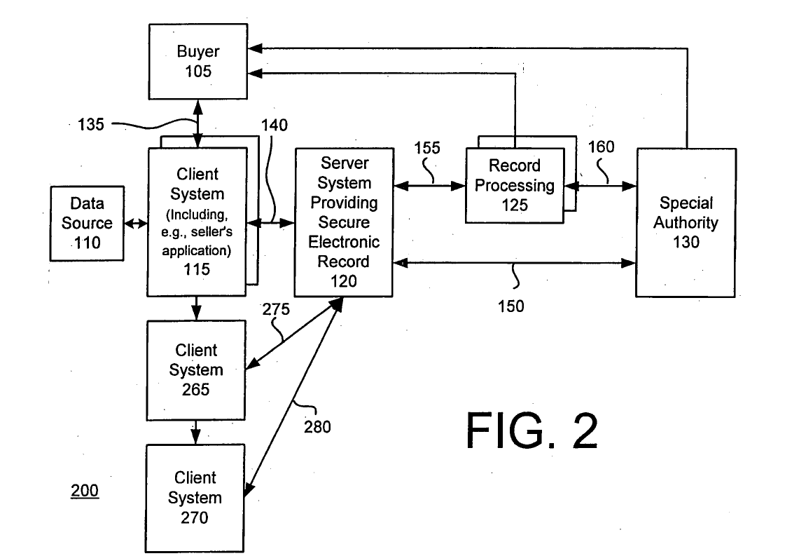

FIG. 2 is a block diagram of selected elements of distributed system 200 providing secure electronic record services according to an alternative embodiment of the invention. Some of the elements in FIG. 2 are similar to (or the same as) corresponding elements shown in FIG. 1 and those elements share the same reference numerals. Distributed system 200 also includes client systems 265 and 270. In an embodiment, client systems 265 and 270 are successively connected to provide additional processing to transaction data corresponding to a transaction between buyer 105 and client system 115. For example, client system 115 may receive a buyer's order, client system 265 may determine whether the order can be filled by an associated business, and client system 270 may complete the transaction between buyer 105 and client system 115.

In an embodiment, client system 115 receives transaction data from buyer 105. Client system 115 may perform some processing of the received transaction data and may also send transaction data to server system 120. Client system 115 may also forward the received transaction data to client system 265. Client system 265 may perform further processing and/or additional processing for the received transaction data and may also pass transaction data to server system 120 through connection 275. In an embodiment, client system 265 passes the transaction data to client system 270 for yet further and/or yet additional processing. Client server 270 may pass the processed data to client system 120 over connection 280.

FIG. 3 is a block diagram of selected elements of distributed system 300 providing secure electronic record services according to yet another alternative embodiment of the invention. Some of the elements in distributed system 300 are similar to (or the same as) the elements shown in FIG. 1 and those elements share the same reference numerals. In addition, distributed system 300 includes record processing systems 365 and 770.

As discussed above, server system 120 may provide data according to a uniform encoding standard and having semantics that are shared by, for example, special authority 130, record processing systems 125, 365, and 370, client system 115, data source 110, and/or buyer 105. Since server system 120 may provide data having semantics that are shared with other elements of distributed system 300, record processing systems 125, 365, and 370 may easily perform additional processing and record keeping tasks such as filling forms and/or providing statistical analysis of transaction related data. For example, record processing systems 125, 365, and 370 may be, respectively, an accounting application, an electronic form (e.g., tax form) generating application, and a statistical analysis application. Accounting application 125 may receive transaction data from server system 120, determine that at least a portion of that data should be reported to a tax authority, and forward the specified portion of transaction data to electronic form generating application 365. Electronic form generating application 365 may receive the specified transaction data and generate a corresponding tax form. The electronic tax form may be passed to and processed by statistical analysis application 370. In an embodiment statistical analysis application 370 (or another record processing system) may pass the completed and analyzed tax form to special authority 130.

Connections 370 and 375 illustrate that buyer 105 may receive a copy of the generated secure electronic record at nearly any point in the chain of processing between server system 120 and special authority 130. Connections 370, 375, 380, 385, 390, 395 may be wired or wireless connections including LANs, WANs, MANs, and/or the Internet. In an embodiment, the elements of distributed system 300 communicate with each other via the HTTP Protocol and/or the HTTPS Protocol.

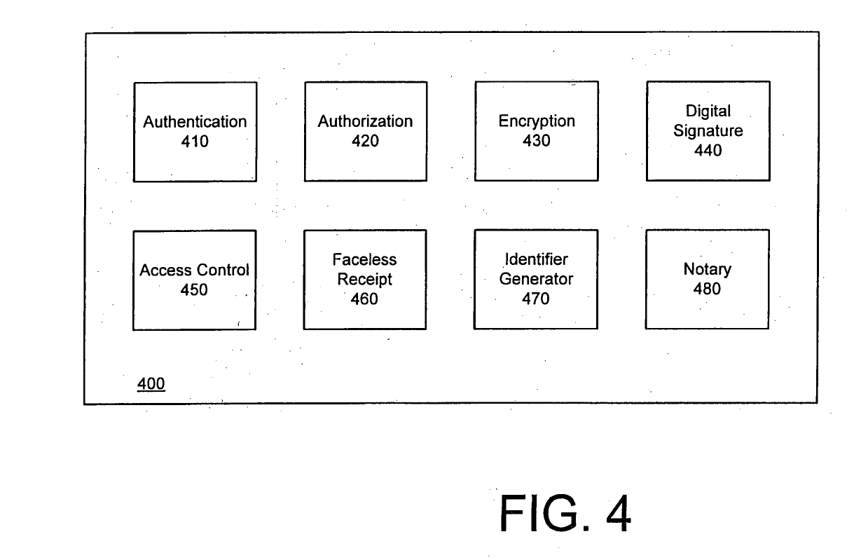

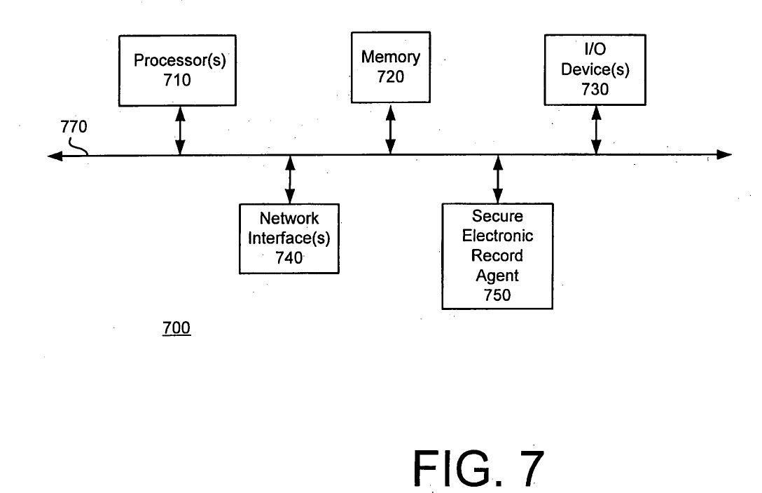

FIG. 4 is a block diagram illustrating the architecture of an embodiment of secure electronic record agent 400. The illustrated embodiment of secure electronic agent 400 includes authentication module 410, authorization module 420, Encryption module 430, digital signature module 440, access control module 450, faceless receipt module 460, identifier generator 470, and notary module 480. In an embodiment of the invention, secure electronic record agent 400 provides secure electronic record services in a distributed computing system. In an embodiment, secure electronic record agent 400 executes in a node (e.g., node 700 shown in FIG. 7) and enables the node to provide secure electronic record services in a distributed computing system. Secure electronic record agent 400 may be executable content, control logic, firmware, or some combination thereof. In embodiments of the invention in which agent 400 is executable content, it may be stored in memory (e.g., memory 720 shown in FIG. 7) and executed by a processor (e.g., processor 710 shown in FIG. 7).

In an embodiment, authentication module 410 is an implementation of RFC 2617. In alternative embodiments of the invention, authentication module 410 may implement a different and/or an additional authentication protocol. In an embodiment, encryption module 430 may be an implementation of the XML Encryption Standard. In alternative embodiments, encryption module 430 may implement a different encryption standard (and/or protocol). In an embodiment, digital signature module 440 and/or access control module 450 are implementations of RFC 3275. In alternative embodiments, digital signature module 440 and access control module 450 may implement a different protocol (and/or standard).

In an embodiment, authorization module 420 determines whether a client interacting with secure electronic agent 400 is authorized to receive services from secure electronic agent 400. In an embodiment, authorization module 420 is an implementation of RFC 2617. In an alternative embodiment, authorization module 420 implements another and/or an additional protocol and/or standard.

In an embodiment, identifier generator 470 generates unique record identifiers for each secure electronic record generated by secure electronic record agent 400. In an embodiment, the record identifiers are numbers or string literals that uniquely distinguish the generated secure electronic record. Identifier generator 470 may implement any specification that specifies generating unique identifiers.

In an embodiment, notary module 480 retains copies of generated secure electronic records and administers them for a predetermined length of time. In an embodiment, the administrative functions that notary module 480 performs for copies of generated records includes generating further copies, conformity check of generated copies, and/or revision of generated copies. In an embodiment, notary module 480 provides the copies to, for example, buyer 105 shown in FIG. 1.

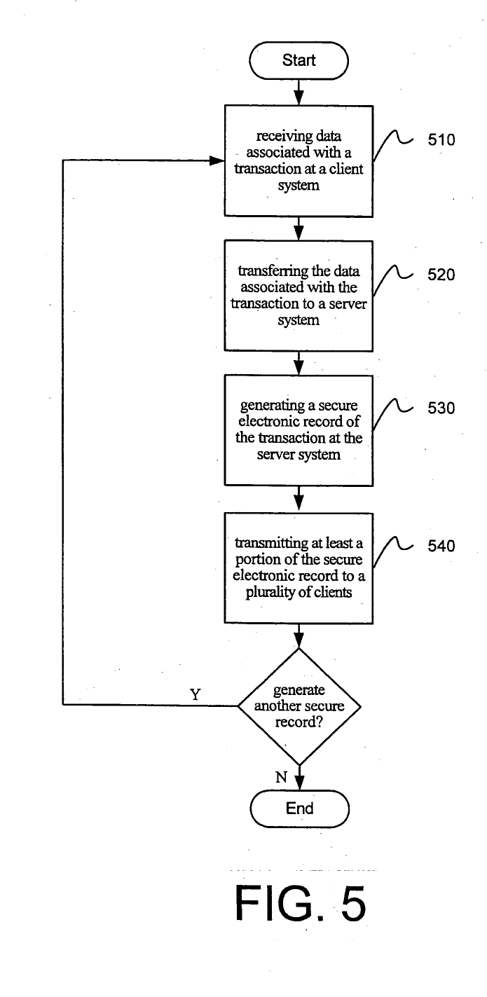

Turning now to FIGS. 5 and 6, the particular methods associated with embodiments of the invention are described in terms of computer software and hardware with reference to a flowchart. The methods to be performed by a secure electronic record agent may constitute state machines or computer programs made up of computer-executable instructions. Describing the methods by reference to a flowchart enables one of ordinary skill in the art to develop such programs including such instructions to carry out the methods on suitably configured computing devices (e.g., one or more processors of a node) executing the instructions from computer-accessible media. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

FIG. 5 is a flow diagram illustrating certain aspects of a method for processing data associated with a transaction, according to an embodiment of the invention. Referring to process block 510, in an embodiment, data associated with a transaction is received at a client system. In an embodiment, the client system is associated with a seller of a product or service and the transaction data is associated with the sale of the product or service. The received transaction data may include an authentication token as specified in RFC 2617. In an embodiment, the received transaction data includes a digital signature as specified by RFC 3275.

Referring to process block 520, the received transaction data is transferred to a server system. In an embodiment, the server system provides secure electronic record services to a plurality of client systems. As described above the transferred data (and/or the received data) may have a uniform data format and may have data semantics that are understood by both client systems and the server system. In an embodiment, the transfer of transaction data is performed according to a request/response model. For example, the client system may send a request to generate a secure electronic record to the server system. In response, the server system may request at least a portion of the transaction data from the client system. In an embodiment, the transaction data is transferred according to the HTTP Protocol. In alternative embodiments, a different transport protocol may be used.

Referring to process block 530, the server system may generate a secure electronic record corresponding to the transaction. As described above with reference to FIGS. 1 through 4, the server system may provide a number of security features including: authentication, authorization, encryption, digital signatures, access control, faceless receipts, unique identifiers, and/or notary services. In an embodiment, the generated secure electronic records have a uniform data format and also have data semantics that are understood by a plurality of record processing clients.

Referring to process block 540, the server system transmits the secure electronic record to a plurality of clients. In an embodiment, the secure electronic record may be transferred to a special authority. Examples of a special authority include a tax collecting authority and/or a customs authority. The plurality of clients may also include one or more record processing systems. The record processing systems may perform a variety of form completing, data analysis, and/or accounting functions. In an embodiment, only selected portions of a generated secure electronic record are transmitted to particular clients. In an embodiment, the server system (and/or a client system) specifies which clients have access to which portions of the generated secure electronic record.

FIG. 6 is a flow diagram illustrating certain aspects of a method for generating a secure electronic record, according to an embodiment of the invention. Referring to process block 610, received transaction data is authenticated according to, for example, RFC 2617. A digital signature may be created for the generated secure electronic record according to, for example, RFC 3275, at process block 620.

Referring to process block 630, at least a portion of the generated secure electronic record may be encrypted. In an embodiment, encryption may be performed according to the XML Encryption Standard. An identifier for the secure electronic record is generated at process block 640. In an embodiment, the identifier uniquely identifies the secure electronic record.

Referring to process block 650, access control restrictions are implemented for the generated secure electronic record. For example, a hidden part and a visible part may be generated for the secure electronic record. The hidden part of the secure electronic record refers to a part of the record that is not visible to at least a subset of a plurality of receivers. In an embodiment, parts of the secure electronic record are encrypted to make them “hidden” to receivers who are not enabled to decrypt them. Hidden parts of the secure electronic record, from the perspective of a given receiver, may be targeted to another receiver who is involved later in the same processing chain.

FIG. 7 is a block diagram of node 700 implemented according to an embodiment of the invention. Node 700 may include: processor(s) 710, memory 720, one or more Input/Output devices 730, network interface(s) 740, and secure electronic record agent 750. The illustrated elements may be connected together through system interconnection 770. Processor(s) 710 may include a microprocessor, microcontroller, field programmable gate array (FPGA), application specific integrated circuit (ASIC), central processing unit (CPU), programmable logic device (PLD), and similar devices that access instructions from system storage (e.g., memory 720), decode them, and execute those instructions by performing arithmetic and logical operations.

Secure electronic record agent 750 enables node 700 to provide secure electronic record services to one or more client systems. Secure electronic record agent 750 may be executable content, control logic (e.g., ASIC, PLD, FPGA, etc.), firmware, or some combination thereof, in an embodiment of the invention. In embodiments of the invention in which secure electronic record agent 750 is executable content, it may be stored in memory 720 and executed by processor(s) 710.

Memory 720 may encompass a wide variety of memory devices including read-only memory (ROM), erasable programmable read-only memory (EPROM), electrically erasable programmable read-only memory (EEPROM), random access memory (RAM), non-volatile random access memory (NVRAM), cache memory, flash memory, and other memory devices. Memory 720 may also include one or more hard disks, floppy disks, ZIP disks, compact disks (e.g., CD-ROM), digital versatile/video disks (DVD), magnetic random access memory (MRAM) devices, and other system-readable media that store instructions and/or data. Memory 720 may store program modules such as routines, programs, objects, images, data structures, program data, and other program modules that perform particular tasks or implement particular abstract data types that facilitate system use.

One or more I/O devices 730 may include a hard disk drive interface, a magnetic disk drive interface, an optical drive interface, a parallel port, serial controller or super I/O controller, serial port, universal serial bus (USB) port, a display device interface (e.g., video adapter), a network interface card (NIC), a sound card, modem, and the like. System interconnection 770 permits communication between the various elements of node 700. System interconnection 770 may include a wide variety of signal lines including one or more of a memory bus, peripheral bus, local bus, host bus, bridge, optical, electrical, acoustical, and other propagated signal lines.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

1. A computer-implemented method comprising:
receiving a request to generate a secure electronic record of a third-party transaction, wherein the received request includes data associated with the third-party transaction;
generating the secure electronic record of the third-party transaction; and
transmitting at least a portion of the secure electronic record to a client system.

2. The method of claim 1, wherein generating the secure electronic record of the third-party transaction comprises:
generating a hidden part of the secure electronic record to be accessible by at least a subset of a plurality of clients; and
generating a visible part of the secure electronic record to be accessible by at least a subset of the plurality of clients.

3. The method of claim 1, wherein generating the secure electronic record of the third-party transaction comprises:
authenticating the received data associated with the third-party transaction.

4. The method of claim 1, wherein generating the secure electronic record of the third-party transaction comprises:
generating a digital signature for the secure electronic record.

5. The method of claim 1, wherein generating the secure electronic record of the third-party transaction comprises:
encrypting at least a portion of the secure electronic record.

6. The method of claim 1, wherein generating the secure electronic record of the third-party transaction comprises:
providing an identifier for the secure electronic record to uniquely identify the secure electronic record.

7. The method of claim 1, wherein generating the secure electronic record of the third-party transaction comprises:
generating a secure electronic receipt of the third-party transaction

8. The method of claim 1, wherein receiving data associated with the third-party transaction further comprises:
receiving data associated with the third-party transaction from a first client system; and
receiving data associated with the third-party transaction from a second client system, wherein the second client system receives at least a portion of the data associated with the third-party transaction from the first client system.

9. The method of claim 1, wherein receiving data associated with the third-party transaction comprises:
receiving an authentication token corresponding to the data associated with the third-party transaction.

10. The method of claim 1, wherein receiving data associated with the third-party transaction comprises:
receiving a digital signature corresponding to the data associated with the third-party transaction.

11. The method of claim 1, wherein the secure electronic record is a secure electronic receipt.

12. The method of claim 11, wherein receiving data associated with the third-party transaction comprises:
receiving the data according to the HyperText Transfer Protocol (HTTP).

13. The method of claim 1, wherein transmitting at least a portion of the secure electronic record to a client further comprises:
transmitting a first portion of the secure electronic record to a first client; and
transmitting a second portion of the secure electronic record to a second client.

14. The method of claim 1, wherein transmitting at least a portion of the secure electronic record to a client comprises:
transmitting at least a portion of the secure electronic record to a special authority.

15. The method of claim 14, wherein the special authority is a tax collecting authority.

16. The method of claim 1, wherein the received request specifies at least some of a plurality of clients to which the secure electronic record is transmitted.

17. The method of claim 1, wherein the received request defines a portion of the secure electronic record that is transmitted to the client.

18. The method of claim 1, further comprising:
encrypting, at least a portion of, the generated secure electronic record of the third-party transaction.

19. The method of claim 1, further comprising:
obtaining a digital signature corresponding to the received data associated with the third-party transaction.

20. The method of claim 1, further comprising:
authenticating the received data associated with the third-party transaction.

21. The method of claim 1, wherein the client is a special authority client system.

22. The method of claim 21, wherein the special authority client system is a tax collecting authority client system.

23. The method of claim 1, further comprising:
maintaining a copy of the transmitted portion of the secure electronic record to validate the transfer of the secure electronic record.

24. A system comprising:
a secure electronic record server system to generate a secure electronic record responsive to receiving data associated with a third-party transaction; and
a plurality of client systems coupled with the server system to receive the secure electronic record from the secure electronic record server system.

25. The system of claim 24, wherein the plurality of client systems includes a tax collecting authority client system.

26. The system of claim 24, wherein the secure electronic record is a secure electronic receipt.

27. The system of claim 24, wherein the secure electronic record server system is coupled with the plurality of client systems through the Internet.

28. The system of claim 27, wherein the secure electronic record server system comprises:
an authentication mechanism to authenticate the received data associated with the third-party transaction.

29. The system of claim 28, wherein the authentication mechanism implements, at least in part, Request For Comments 2617 to authenticate the received data associated with the third-party transaction.

30. The system of claim 27, wherein the secure electronic record server system comprises:
an encryption mechanism to encrypt at least a portion of the secure electronic record.

31. The system of claim 30, wherein the encryption mechanism implements, at least in part, the Extensible Markup Language Encryption Standard to encrypt at least a portion of the secure electronic record.

32. The system of claim 27, wherein the secure electronic record server system comprises:
a digital signature mechanism to verify that the received data associated with the third-party transaction has not been altered.

33. The system of claim 32, wherein the digital signature mechanism implements, at least in part, Request For Comments 3275 to verify that the received data associated with the third-party transaction has not been altered.

34. The system of claim 24, wherein the secure electronic record server system comprises:
an identifier generator to provide a unique identifier for the secure electronic record.

35. An application server comprising:
a network interface to connect to a client system;
a processor and logic executable thereon to
receive a request to generate a secure electronic record of a third-party transaction from the client system, wherein the received request includes data associated with the third-party transaction,
generate a secure electronic record of the third-party transaction, and
transmit at least a portion of the secure electronic record to a plurality of clients; and
a network interface to connect to at least one of the plurality of clients.

36. The application server of claim 35, wherein the processor and logic executable thereon to generate the secure electronic record of the third-party transaction at the server system includes logic executable thereon to:
authenticate the received data associated with the third-party transaction.

37. The application server of claim 35, wherein the processor and logic executable thereon to generate the secure electronic record of the transaction at the server system includes logic executable thereon to:
reference a digital signature associated with the received data to determine whether the received data has been altered.

38. The application server of claim 35, wherein the processor and logic executable thereon to generate the secure electronic record of the transaction at the server system includes logic executable thereon to:
encrypt at least a portion of the secure electronic record.

39. The application server of claim 35, further comprising:
an identifier generator to provide a unique identifier for the secure electronic record.

40. An application server comprising:
means for receiving a request to generate a secure electronic record of a third-party transaction, wherein the received request includes data associated with the third-party transaction;
means for generating the secure electronic record of the third-party transaction; and
means for transmitting at least a portion of the secure electronic record to a plurality of client systems.

41. The system of claim 40, wherein the means for generating the secure electronic record of the third-party transaction comprises:
means for generating a hidden part of the secure electronic record to be accessible by a subset of the plurality of clients; and
means for generating a visible part of the secure electronic record to be accessible by the plurality of clients.

42. The system of claim 40, wherein the means for generating the secure electronic record of the transaction at the server system comprises:
means for authenticating the received data associated with the transaction.

43. The system of claim 40, wherein the means for generating the secure electronic record of the third-party transaction comprises:
means for creating a digital signature associated with the generated secure electronic record to provide an indication of whether the generated secure electronic record has been altered.

44. The system of claim 40, wherein the means for generating the secure electronic record of the third-party transaction comprises:
means for encrypting at least a portion of the secure electronic record.

45. The system of claim 40, wherein the means for generating the secure electronic record of the third-party transaction comprises:
means for providing an identifier for the secure electronic record to uniquely identify the secure electronic record.

46. The system of claim 40, wherein the means for generating the secure electronic record of the third-party transaction comprises:
means for generating a secure electronic receipt for the third-party transaction.

47. An article of manufacture comprising:
an electronically accessible medium providing instructions that, when executed by an apparatus, cause the apparatus to
receive a request to generate a secure electronic record of a third-party transaction, wherein the received request includes data associated with the third-party transaction;
generate the secure electronic record of the third-party transaction; and
transmit at least a portion of the secure electronic record to a plurality of clients.

48. The article of manufacture of claim 47, wherein the electronically accessible medium provides further instructions that, when executed by the apparatus, cause the apparatus to
encrypt the generated secure electronic record of the third-party transaction.

49. The article of manufacture of claim 47, wherein the electronically accessible medium provides further instructions that, when executed by the apparatus, cause the apparatus to
obtain an electronic signature corresponding to the received data associated with the third-party transaction.

50. The article of manufacture of claim 47, wherein the electronically accessible medium provides further instructions that, when executed by the apparatus, cause the apparatus to
authenticate the received data associated with the third-party transaction
